(19) United States
(12) Patent Application Publication
(10) Pub. No.: US 2022/0119606 A1
(43) Pub. Date: Apr. 21, 2022

(54) PROCESS FOR PRODUCING A FIBER COMPOSITE

(71) Applicant: Dow Global Technologies LLC, Midland, MI (US)

(72) Inventors: Sarah N. O'keeffe, Hemlock, MI (US); David H. Bank, Midland, MI (US)

(21) Appl. No.: 17/431,704

(22) PCT Filed: Feb. 13, 2020
(86) PCT No.: PCT/US2020/018040

§ 371 Date: Aug. 17, 2021

Related U.S. Application Data
(60) Provisional application No. 62/811,585, filed on Feb. 28, 2019.

(51) Int. Cl. C08J 5/24; B29C 70/50

(52) U.S. Cl. CPC C08J 5/243; B29K 2307/04; B29C 70/504

(57) ABSTRACT

A prepreg, carbon fiber reinforced composite, and a process for prepreg production including the steps of: (a) providing a fast curing resin composition; (b) forming a film from the resin of step (a) on one side surface of a release substrate sheet; (c) providing a fiber fabric substrate sheet having a varying fiber areal weight cross-sectional thickness; (d) contacting at least one side surface of the fiber fabric substrate sheet of step (c) with the film of step (b); (e) applying pressure on the other side surface of the release substrate sheet opposite the resin film of step (b) to impregnate the fiber fabric substrate sheet of step (c) with the resin composition of step (a); and (f) allowing the fiber fabric substrate sheet impregnated with the resin composition of step (e) to partially cure to form a prepreg product. Also S-wrap compaction roll assembly having at least three rolls, wherein the second nip roller that is positioned between the other two includes a modified diameter.

### FIELD

The present invention relates to a process for producing a fiber composite; and more particularly, the present invention relates to a process for preparing a carbon fiber epoxy resin composite having a varying fiber areal weight.

### BACKGROUND

In general, it is known to produce carbon fiber composites by first forming a prepreg structure by impregnating fibers or fabric with a resin formulation, such as an epoxy resin formulation, and then curing the impregnated prepreg structure to form the carbon fiber composite. Carbon fiber epoxy composites can be used for many applications including, for example, manufacturing automotive parts. In automotive applications there is a need to create a carbon fiber epoxy composite with continuous aligned fabrics that may have varying fiber areal weight (FAW) across the width of the fabric. To be useful in automotive applications, impregnated fibers or fabrics need to: (1) be compression molded and cured in less than 5 minutes (min), (2) retain a high glass transition temperature, and (3) achieve high strength and stiffness properties with the use of an internal mold release agent to allow cured parts to easily release from molds.

Heretofore, impregnation methods used for impregnating fabrics, such as the methods disclosed in EP2692783B1 and EP3216496A1, have been carried out on prepregs with a uniform FAW and the known methods assume a singular thickness of the reinforcement layer of the prepreg. Problems occur with the use of known impregnation methods; when such known impregnation methods are used for impregnating a resin into a fabric of varying fiber areal weight (of varying thickness), that is, a fabric having both high areal weight sections and low areal weight sections. For example, when a known impregnation method is used on a fabric of varying fiber areal weight, either the high areal weight section of the fabric becomes distorted or the low areal weight section of the fabric is not infused with resin. Typically, a fabric of a variable carbon fiber areal weight braided architecture has a high fiber areal weight (e.g., 588 grams per square meter (g/m²)) in the center of the fabric and a low fiber areal weight (e.g., 520 g/m²) at the ends of the fabric.

It would be desirous to provide a method or process of impregnating a carbon fabric with an epoxy resin formulation, wherein the carbon fabric has a variable carbon fiber areal weight braided architecture followed by preparing a prepreg from the epoxy resin impregnated carbon fabric without the aforementioned distortion problems.

### SUMMARY

One embodiment of the present invention is directed to a process for producing a prepreg product including the steps of: (a) providing a fast curing resin composition; (b) forming a film of the resin from step (a) on the surface of one side of a sheet of release substrate; (c) providing a sheet of a fiber fabric substrate having a cross-sectional thickness of a varying fiber areal weight; (d) contacting the surface of at least one side of the sheet of fiber fabric substrate of step (c) with the resin of the sheet of resin film of step (b); (e) applying pressure on the surface of the other side of the sheet of release substrate opposite the resin film to impregnate the fiber fabric substrate with the fast curing resin composition; and (f) allowing the fiber fabric substrate impregnated with the fast curing resin composition of step (e) to partially cure to form a prepreg product.

In another embodiment, the process of the present invention includes impregnating an epoxy resin into a carbon fabric having a varying fiber areal weight and then forming a prepreg from the carbon fiber fabric impregnated with the epoxy resin.

In still another preferred embodiment, the present invention process uses a targeted average film thickness (for example, 540 g/m²) for pre-pregging the fabric having a variable fiber areal weight carbon fiber architecture and creating equal pressure by adding release paper to the desired location (low fiber areal weight) to create the even pressure (across, for example, a 12-inch (30.48 centimeters (cm)) width of the fabric) needed for impregnation without distorting the fabric.

In yet another preferred embodiment, the present invention includes a nip roll assembly apparatus for producing a resin-impregnated prepreg product.

The present invention utilizes a single layer (with all fiber angles contained within the same prepreg) broadgood prepreg with varying thickness across the width to mold complex cross-section tubular shapes with non-uniform diameters.

Advantageously, the prepreg produced by the process of the present invention can be molded to form molded fiber reinforced composite structures with complex cross-sections, such as tubular non-uniform diameter parts.

### BRIEF DESCRIPTION OF THE DRAWINGS

FIG. 1 is a perspective view of a schematic diagram of a S-nip roller system apparatus which can be used to form a prepreg product such as the prepreg shown in FIG. 3 described below.

FIG. 2 is a cross-sectional view taken along line 2-2 of FIG. 1.

FIG. 3 is enlarged cross-sectional view of a prepreg product of a “dumb bell” shape which has been formed by impregnating a carbon fiber fabric substrate with an epoxy resin using the apparatus of FIG. 1.

FIG. 4 is an enlarged cross-sectional view of another shaped prepreg product which has been formed by impregnating a carbon fiber fabric substrate with an epoxy resin.

### DETAILED DESCRIPTION

“Broadgood” is a term used in the textiles industry for cloth woven in standard or wider widths especially in distinction from ribbons, bands, or trimmings; which generally includes woven fabrics that are over 18 inches (450 millimeters) wide.

“Infusing”, “impregnating” and “pre-pregging” are used herein interchangeably with reference to a resin composition contacting a fibrous material, and herein means flowing the resin composition into the body of a fibrous material to fill, permeate or saturate the fibrous material with the resin composition.

In a broad scope embodiment, the process for producing a prepreg product of the present invention includes impregnating a fiber fabric substrate having a cross-sectional thickness of a varying fiber areal weight with a fast curing resin composition; applying a varying pressure along the horizontal axis of the resin-impregnated fiber fabric substrate; and partially curing the fiber fabric substrate impregnated with the fast curing resin composition to form a prepreg product.

The fast curing resin composition useful in the process of the present invention can include, for example, a fast curing epoxy resin system, formulation or composition. In one preferred embodiment, for example, the fast curing epoxy resin composition described in WO2017066056 can be used in the process of the present invention. The fast cure epoxy resin composition useful in the present invention includes an epoxy resin composition that provides a more homogeneous infusion of the resin into a fibrous material for forming a prepreg or composite article.

As described in WO2017066056, the fast cure epoxy resin composition useful in the present invention includes an epoxy resin composition comprising a solid epoxy resin containing an oxazolidone as a first epoxy component, a second epoxy component, a soluble latent catalyst, and a latent hardener having a particle distribution in which at least 35 weight percent (wt %) of particles, based on the total weight of the hardener, have an average particle size of less than 2 microns (μm). By using a latent hardener having the desired particle distribution (e.g., at least 35 percent (%) of the particles have a diameter of less than 2 μm), a more homogeneous infusion of the epoxy resin composition into the fibrous material may be achieved. In turn, this provides an epoxy resin composition having faster cure rates, which reduces mold cycle times, and thereby increases the rate at which articles and parts molded from prepregs may be prepared.

In one general embodiment, it is desired that the epoxy resin composition selected for infusion, have a glass transition temperature (Tg) of from 0 degrees Celsius (° C.) to less than 15° C. At these Tg levels, advantageously, the epoxy resin composition can be rapidly infused into the fibrous material while minimizing and reducing void spaces (e.g., pockets of air bubbles) within the prepreg.

The epoxy formulation described above advantageously provides: (1) a prepreg in a relatively fast rate of cure (e.g., curable at 150° C. in 3 minutes (min)); (2) provides a low to negligible tack carbon fiber prepreg; (3) provides prepreg with a long shelf-life (e.g., greater than 40 days at 23° C. and at least 1 year at −20° C.; and (4) provides a final cured fiber reinforced composite having a high Tg (on-set) of, for example, greater than 100° C.; and a Tg (peak Tan delta) of, for example, greater than 140° C. Another benefit of the using the above epoxy resin system is that the resin is curable without use of an external mold release agent.

Once the epoxy resin composition described above is prepared, the epoxy resin composition may be infused into a fibrous material in the form of tows or fabrics (e.g. a roll of carbon fiber fabric) to form a prepreg in accordance with the process of the present invention. The above described epoxy resin compositions in accordance with embodiments of the present invention may be combined with a wide variety of different reinforcing fibers. The fibers of the fabric used in the present invention may include, for example, carbon fibers, graphite fibers, glass fibers, ceramic fibers, aramid fibers, natural fibers (such as basalt, hemp, seagrass, hay, flax, straw, jute, or coconut). In one preferred embodiment, carbon fibers are used may be in the form of fabrics and may be in the form of random, knitted, non-woven, multi-axial (e.g., non-crimped fabric), braided or any other suitable pattern. The fabric should be thermally and chemically stable under conditions of prepreg formation (e.g., curing of the epoxy resin composition); and the fabric should be compatible with the resin selected to be used in the infusion process of the fabric.

In one preferred embodiment, the process of the present invention for producing a prepreg product includes the steps of: (a) providing a fast curing resin composition; (b) forming a film of the resin from step (a) on the surface of one side of a sheet of release substrate; (c) providing a sheet of a fiber fabric substrate having a cross-sectional thickness of a varying fiber areal weight; (d) contacting the surface of at least one side of the sheet of fiber fabric substrate of step (c) with the resin of the sheet of resin film of step (b); (e) applying a pressure on the surface of the other side of the sheet of release substrate opposite the resin film to impregnate the fiber fabric substrate with the fast curing resin composition; and (f) allowing the fiber fabric substrate impregnated with the fast curing resin composition of step (e) to partially cure to form a prepreg product.

Generally, the process of preparing a prepreg of the present invention includes forming a film or sheet of the above described fast curing resin composition from the above step (a) onto the surface of one side of a sheet material. For example, this step (b) can be accomplished by extruding the resin composition, such as an epoxy resin, onto the sheet material to form a film resin coating on the sheet material. The resultant thickness of the film resin can vary depending on the end prepreg product to be produced. For example, in one general embodiment, and not to be limited thereby, the thickness can be from 0.0119 inches (0.03 cm) to 0.0125 inches (0.032 cm) for a FAW material. Generally, the thickness of the film resin can be such that the resin is at least from 30 wt % to 50 wt % of the prepreg composite in one embodiment; and from 35 wt % to 45 wt % in another embodiment. In a preferred embodiment, the thickness of the film resin can be at least 40 wt % of the prepreg composite; and the fiber substrate can be at least 60 wt % of the prepreg composite.

The sheet material can be a release film or paper from which the film coating of the epoxy resin composition which will be transferred to the fibrous material during the contacting step (pre-pregging) of the process. The sheet material comprising a film or paper can be made, for example, of a sheet of paper coated with a release agent or a sheet of Telfon material, and the like. In one general embodiment, and not to be limited thereby, the thickness of the thickness of the sheet material can be from 0.007 inches (0.018 cm) to 0.009 inches (0.023 cm) in one embodiment.

After the film of the epoxy resin composition has been deposited on the sheet material, the sheet material with the film resin coating may be passed over a chill roll to cool the epoxy resin composition. The sheet material with the cooled epoxy resin composition can then be wound on a roll for immediate use or for future use. In one preferred embodiment, the release paper or film on which the epoxy resin composition is coated as a film can be rewound on a roll for later use following the step of cooling the epoxy resin composition.

In one embodiment of the process, the sheet material having the epoxy resin composition film coating can be brought into contact with a surface of the above described fiber fabric substrate or fibrous material (e.g., NCF, braided, or unidirectional fabric) from the above step (c). Then, the fibrous material and the sheet material having the epoxy resin composition film coating can be subjected to pressure, either subsequent to the contacting step or during the contacting step, to infuse the epoxy resin into the fibrous material.

A standard conventional prepreg line known in the art and ancillary equipment for the prepreg line can be used for the contacting step and the subsequent or simultaneous impregnation step. The prepreg line used in the present invention process can be any known prepreg line including, for example, (1) an unwind station, (2) a heated table (with insulator pad), (3) S-wrap compaction rollers, and (4) a pull roller to control speed.

In one preferred embodiment, the sheet of fibrous material can be sandwiched between two sheet materials on which film coatings of the epoxy resin composition are deposited; and the fibrous material and the sheet material coated with the epoxy resin composition can be provided as continuous tapes from respective supply rolls. The contacting step of the present invention process can be carried out in the above described film forming equipment used to form sheets and compressing sheets of different substrates together using an S-wrap nip compaction roll system apparatus. However, in a preferred embodiment of the present invention, the apparatus is modified to accommodate a desired fiber fabric substrate having a varying fiber areal weight. In addition, the apparatus is modified to provide an even pressure along the thickness of the fiber fabric substrate having a varying fiber areal weight.

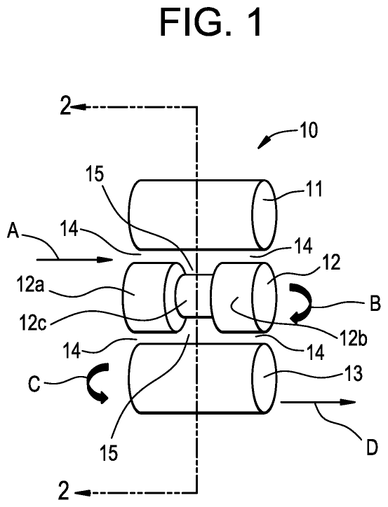

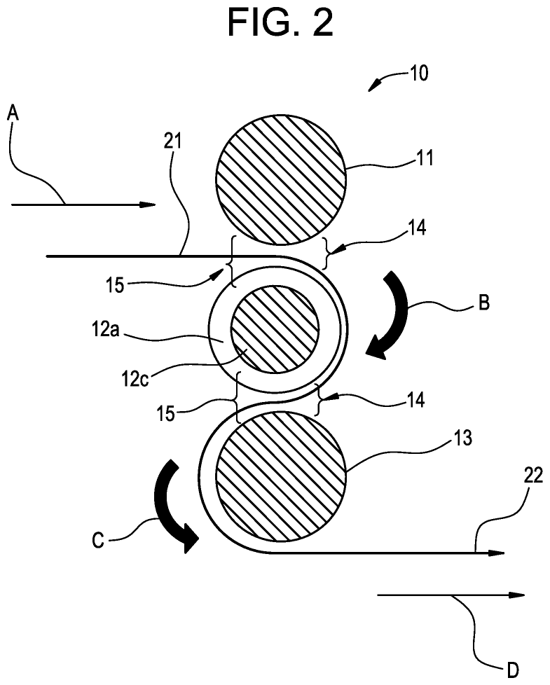

With reference to FIGS. 1 and 2, there is shown a preferred modified embodiment of the S-wrap compaction rollers used in the present invention, generally indicated by reference numeral 10, including a series of nip rollers such as a top nip roller 11, a middle nip roller 12 and a bottom nip roller 13. In one embodiment, a sandwiched material is fed into the roller system 10 as shown with direction arrow A. The sandwiched material passes/turns through the roller system 10 in the direction as indicated by direction turning arrows B and C (shown in FIG. 2). And an infused fibrous material exits the roller system 10 as shown with direction arrow D.

In the preferred modified embodiment of the S-wrap compaction rollers, the middle nip roller 12 varies in dimensions as indicated by edge sections 12a and 12b; integral with a middle section 12c. In general, the shape of the nip roller member 12 can be described as two cylindrical members joined together by, and integral with, a middle bar section; or in simple terms the nip roller member 12 can be in the shape of a “dumb bell weight” or a dumb bell-shaped” member 12 when the member 12 is viewed in a front perspective view as shown in FIG. 1. The middle roller 12 can be created by using a predetermined thickness of one or more release papers on the edges of a regular nip roller of a constant diameter and length and “building up” the diameter of the edges 12a and 12b of the nip roller 12 to a desired diameter to provide the preferred shape of nip roller 12 to accommodate the resin impregnated fiber fabric.

The dumb bell-shaped roller, i.e., the middle nip roller 12 disposed in between the np rollers 11 and 13, provides a first gap 14 and a second gap 15 which allow for the desired pressure to be placed on the feed film 21 (shown in FIG. 2).

After the contacting step to bring together the sandwiched materials (i.e., the combination sheet of resin and fibrous material), the sandwiched materials can be passed through a pair of nip rolls that press the epoxy resin composition into opposite surfaces of the fibrous material. The prepreg of the present invention can be produced by infusing (or impregnating) the fibrous material (or carbon fiber fabric substrate) with the epoxy resin composition by application of pressure to the sandwiched materials. In one preferred embodiment, this step (e) of applying pressure is the step that is carried out to impregnate (or infuse) the carbon fiber fabric substrate with the fast curing epoxy resin composition. In another embodiment, the fiber fabric substrate having variable fiber areal weight areas is impregnated with the fast curing resin composition to obtain a uniform impregnation across the width of the variable fiber areal weight composite. A “uniform impregnation” with reference to the impregnation of a resin into a fibrous material, herein means a predetermined level of impregnation is the same across the entire width of the variable fiber areal weight composite including in the low fiber areal weight areas and the high fiber areal weight areas.

In the process of impregnating the above described carbon fiber fabric substrate having a varying fiber areal weight with the above-described epoxy resin composition, the above nip roller system can be used to provide the desired impregnated fiber fabric to form a prepreg. The impregnating step of the process of the present invention includes, for example, feeding into the nip roller system (as shown by arrow A in FIG. 1) a carbon fiber fabric substrate disposed n between two sheets of film of fast curing epoxy resin composition wherein the resin of a top sheet of resin contacts the top surface of the fiber fabric substrate and the resin of a bottom sheet of resin contacts the bottom side surface of the fiber fabric substrate. The carbon fiber fabric substrate impregnated with the fast curing epoxy resin composition then exits the roller system (as shown by arrow D in FIG. 1).

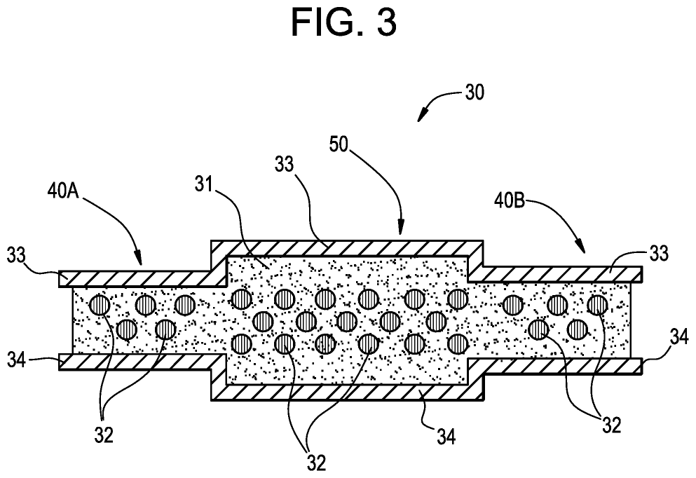

With reference to FIG. 3, there is shown a shaped prepreg, generally indicated by reference numeral 30, including resin matrix 31 infused into a fabric of fibers 32. The prepreg shown in FIG. 3 is the resultant prepreg processed through the S-wrap roller system 10 shown in FIG. 1. A top release paper sheet 33 and a bottom release paper sheet 34 are disposed sandwiching the prepreg 30 in between the top and bottom layers 33 and 34, respectively. The prepreg 30 comprises an edge section, generally indicated by reference numeral 40A and an edge section, generally indicated by reference numeral 40B, both integral with a middle section, generally indicated by reference numeral 50. As shown in FIG. 3, the edge sections 40A and 40B are more compressed than the middle section 50.

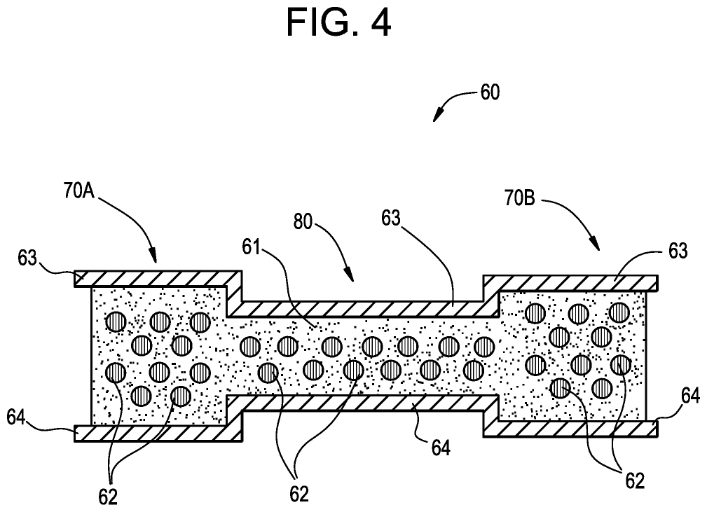

With reference to FIG. 4, there is shown another embodiment of a shaped prepreg, generally indicated by reference numeral 60, including resin matrix 61 infused into a fabric of fibers 62. A top release paper sheet 63 and a bottom release paper sheet 64 are disposed sandwiching the prepreg 60 in between the top and bottom layers 63 and 64, respectively. The prepreg 60 comprises an edge section, generally indicated by reference numeral 70A and an edge section, generally indicated by reference numeral 70B, both integral with a middle section, generally indicated by reference numeral 80. As shown in FIG. 4, the middle section 80 is more compressed than the edge sections 70A and 70B. The prepreg shown in FIG. 4 can also be a resultant prepreg processed through another alternative S-wrap roller system (not shown) having a series of nip rollers (not shown) such as a top nip roller, a middle nip roller, and a bottom nip roller that provides a modified middle nip roller (not shown) in the roller system to provide the shape of the middle section 80 of the prepreg 60.

In one embodiment, the infusion process may be carried out at an elevated temperature so that the viscosity of the epoxy resin composition can be further reduced; and thus, the heating step can facilitate rapid infusion of the epoxy resin composition into the fibrous material. For example, the sandwiched materials can be subjected to heating to raise the temperature of the epoxy resin composition by passing the combination of the fibrous material and the epoxy resin compositions over a heated plate to heat the epoxy resin composition. However, the temperature cannot be so hot for an extended period of time such that an undesirable level of curing of the epoxy resin composition occurs. For example, during the impregnation step (e), the infusion of the epoxy resin composition into the fibrous material can be carried out at temperatures in the range of from 100° C. to 130° C. in one embodiment, from 100° C. to 125° C. in another embodiment; and from 110° C. to 120° C. in still another embodiment. The above heating for infusing the epoxy resin composition into the fibrous material can be carried out using a heated table and using heated nip rolls.

It should be recognized that temperature ranges outside the above ranges may also be used. However, the use of higher or lower infusion temperatures typically requires adjusting the machine speed at which the infusion process is carried out. For example, at temperatures greater than about 120° C., it may be necessary to carry out the infusion process at a higher machine speed in order to reduce the duration of time to which the epoxy resin composition is exposed to an elevated temperature to avoid undesirable crosslinking of the epoxy resin composition. Similarly, to obtain a desired level of infusion and thereby decrease void spaces in the prepreg, the use of a lower infusion temperature will typically require a lower machine speed for infusing the epoxy resin composition into the fibrous material. In one preferred embodiment, the epoxy resin composition can be applied to the fibrous material at a temperature in the range described above; and the epoxy resin composition can be consolidated into the fibrous material by pressure. For example, the pressure exerted on the fibrous material and resin combination can be applied by passing the combination through one or more pairs of nip rollers.

In a preferred embodiment, the combination of the fibrous material and the epoxy resin compositions can be subjected to a further step of passing the combination over a heated plated followed by passing the combination through a second nip to further infuse the epoxy resin composition into the fibrous material to form a resin infused prepreg. The prepreg may then be cooled, for example, by passing the material over a chill roll or a chill plate. After cooling, the prepreg may be wound onto a supply roll for future use.

As discussed above, the infusion step may be performed at an elevated temperature to lower the viscosity of the epoxy resin composition. In addition, the infused epoxy resin composition may be subjected to a partial curing step (advancement) to raise the glass transition temperature of the epoxy resin composition in the prepreg. The prepreg may then be packaged, stored, or shipped as required. As discussed previously, in some embodiments it may also be desirable to subject the prepreg to an advancement step to raise the Tg of the epoxy resin and thereby lower the tack of the prepreg.

In another preferred embodiment, during the impregnation step (e), a compaction roller “nip roll” operation can be used. During the compaction roller “nip roll” operation of a standard prepreg line, additional pressure must be applied to the thinner sections of the prepreg. The nip gap is set to accommodate the thickest section to reduce the distortion seen in this area. A section of release paper with a predetermined thickness (e.g., 0.008 inch (0.02 cm) thick) can be added to a middle roller (S-wrap operation with 3 rollers allowing for 2 nip gaps) in the thinner areas of a broadgood. The use of release paper allows for an even pressure despite the change in thickness to provide optimal infusion of the epoxy resin into the carbon fiber fabric substrate to form a prepreg with minimal distortion.

The conditions of the present invention process of impregnation may vary and can depend on various factors including, for example, the type of fabric used, the size of the fabric used, the FAW of the fabric used, and the design and dimensions of the prepreg product to be produced. As an illustration of the present invention process, and not to be limited thereby, in one specific embodiment a broadgood carbon fiber fabric sheet is feed in between two sheets of an epoxy resin film deposited onto one side of each of the two sheets of release paper with the resin contacting the fabric. The combined sheets are fed into an S-wrap nip roll assembly apparatus the infusion or pre-pregging steps are carried out, for example, as follows:

(1) The nip temperature range can be, for example, from 100° C. to 130° C. in one embodiment, from 100° C. to 125° C. in another embodiment; and from 110° C. to 120° C. in still another embodiment.

(2) The table temperature range can be from 100° C. to 130° C. in one embodiment, from 100° C. to 125° C. in another embodiment; and from 110° C. to 120° C. in still another embodiment.

(3) The first nip gap between the top roll and the middle roll, and between the bottom roll and the middle roll, generally indicated by reference number 14 in FIG. 1 can be from 0.022 inch to 0.026 inch (0.056 cm to 0.066 cm) in one embodiment.

(4) The second nip gap between the top roll and the middle roll; and between the bottom roll and the middle roll, generally indicated by reference number 15 in FIG. 1 can be from 0.022 inch to 0.025 inch (0.056 cm to 0.064 cm) in one embodiment.

(5) The speed of the feed materials into the nip roll system can be from 1.0 ft/min to 2.4 ft/min (0.305 m/min to 0.732 m/min) in one embodiment; from 1.0 ft/min to 2.0 ft/min (0.305 m/min to 0.610 m/min) in another embodiment; and from 1.5 ft/min to 2.0 ft/min (0.457 m/min to 0.610 m/min) in still another embodiment.

The release paper used in the process can have a thickness of from, for example, 0.007 inches (0.018 cm) to 0.009 inches (0.023 cm) in one embodiment. Any standard release paper known in the art can be used in the present invention. The release paper can be used so the material being processes does not stick to the metal roller. Alternatively, the compaction rollers could be altered to account for the change in thickness. For example, instead of adding release paper to the metal roller, the metal roller could be machined in such a way to compensate for the thickness change.

The parameters useful in the present invention can be a “fixed” parameter, that is, a parameter that does not change throughout the set of processing runs of fabric and resin sheets. For example, the nip temperature and the table temperature described above can be fixed parameters. To illustrate the present invention but not to be limited thereto, in one embodiment a nip gap range of 0.023 inch to 0.026 inch (0.058 cm to 0.066 cm), a release paper added, and a slower speed of 1.8 ft/min (0.549 m/min) can be used to demonstrate the utility of the present invention. The nip temperatures and table temperature can remain fixed throughout the present invention process.

Once the fiber fabric substrate impregnated with the fast curing epoxy resin composition of step (e) exits the nip roller system, the impregnated fabric is allowed to partially cure to form a prepreg product. Thereafter, the produced prepreg can be rolled up onto a core; and then the roll of prepreg can be forwarded to storage (the prepreg is stable in storage as described above) or the prepreg can be used in a molding process.

The prepreg produced by the process of the present invention beneficially exhibits a low tack property, i.e., the prepreg is easily handleable; and the prepreg does not stick together at room temperature when used or stored in a roll.

Using the process of the present invention, the prepreg advantageously is not over-crosslinked, i.e., since the prepreg has a Tg of less than 20° C., the prepreg does not exhibit problems such as the generation of voids in the prepreg. A prepreg that is processed using infusion at a high pre-pregging temperature can result in an undesirable “over-cooked” prepreg that has a Tg of above 20° C. which can exhibit an undesirable surface quality, and can become stiff and hard to work with.

In one broad embodiment, the carbon fiber reinforced composite of the present invention is a fully cured composite formed by completely curing the prepreg produced as described above. For example, in a broad embodiment, the process for making a carbon fiber reinforced composite includes the steps of: (A) providing a resin impregnated fabric prepreg made by the process as described above; and (B) curing the impregnated fabric prepreg of step (A) to form a fiber reinforced composite article.

In one embodiment, the curing step (or advancing step) to completely cure the prepreg can be carried out by heating the prepreg at a temperature of from 140° C. to 155° C. at a cure time of from 3 min to 5 min.

One of the objectives of the present invention is to manufacture a fiber reinforced composite (e.g., a carbon fiber reinforced composite) having a variable cross-section along the width of the composite. For example, in one preferred embodiment, the fiber reinforced composite can be a tubular member having a variable cross-section along the diameter. The production of a carbon fiber reinforced composite having an FAW of the present invention has, heretofore, not been possible using the methods of the prior art. Advantageously, the carbon fiber composite of the present invention can now be used for manufacturing automotive composites, for example for interior and exterior parts, wherein such parts are of different shapes, sizes and dimensions. For example, in one preferred embodiment, the carbon fiber composite of the present invention can be used to manufacture a composite part that, in turn, can be used in an automobile steering column.

### EXAMPLES

The following examples are presented to further illustrate the present invention in detail but are not to be construed as limiting the scope of the claims. Unless otherwise indicated, all parts and percentages are by weight.

Various raw materials used in the Inventive Examples (Inv. Ex.) and the Comparative Examples (Comp. Ex.) which follow are explained hereinbelow in Table I.

TABLE I
Raw Materials

| Ingredient | Brief Description of Ingredient | Supplier |
|---|---|---|
| VORAFUSE ™ P6300 | An epoxy resin blend with internal mold release agent | The Dow Chemical |
| | | Company (Dow) |
| VORAFUSE ™ P6020 | Hardener paste | Dow |
| VORAFUSE ™ P6030 | Accelerator powder | Dow |
| VORAFUSE ™ P6060 | Epoxy additive | Dow |
| NX10897 - Hybrid | Variable FAW carbon fiber broadgood/fabric having a | A&P Technologies |
| | fiber areal weight of from 520 g/m² to 587 g/m² | |

### Examples 1 and 2 and Comparative Examples A-C

To manufacture a prepreg using a VORAFUSE™ P6300 resin system and a carbon fiber hybrid broadgood provided by A&P, an experimental prepreg line was used at standard pre-pregging conditions used for the manufacture of conventional prepregs. This caused poor infusion on the outside (thin area) and distortion in the middle (thick area) which relates to the appearance/distortion level. The material was only tested when the material had reached an acceptable subjective visible appearance as determined in accordance with a rating scale (described herein below). The nip gap was then set for the average thickness of the prepreg (Comp. Ex. B). Similar results were seen in the first attempt (Comp. Ex. A). Release paper was then added to the middle roller to compensate for the variable fiber areal weight across the width of the material and the nip gap was opened to be set at the thickest portion of the material (Comp. Ex. C). This demonstrated a slight improvement compared with (Comp. Ex. A) and (Comp. Ex. B). The nip gap was decreased and the speed was slowed for additional pressure and time at temperature to improve infusion and distortion (Inv. Ex. 1). This level of acceptance and distortion was acceptable and the material was tested in both the lower and higher FAW areas. In the final run the nip gap was opened slightly to further decrease distortion (Inv. Ex. 2). This improved the appearance level even more and the material was tested again. However, due to the uniqueness of the material, the material was tested in the direction of the intended part (horizontal versus vertical prior testing) thus the difference in storage modulus was to be expected (more fibers running in the direction of the test).

TABLE II
Experimental Runs and Results

| | | Comp. Ex. A | Comp. Ex. B | Comp. Ex. C | Inv. Ex. 1 | Inv. Ex. 2 |
|---|---|---|---|---|---|---|
| Conditions | | | | | | |
| Nip Temperature Range, ° C. | | 100-110 | 100-110 | 100-110 | 100-110 | 100-110 |
| Table Temperature, ° C. | | 120 | 120 | 120 | 120 | 120 |
| Nip Gap 1, cm | | 0.061 | 0.056 | 0.064-0.076 | 0.056-0.064 | 0.061-0.066 |
| Nip Gap 2, cm | | 0.066 | 0.056 | 0.058-0.064 | 0.056-0.065 | 0.058-0.064 |
| Release Paper added? | | No | No | Yes | Yes | Yes |
| Speed, m/min | | 0.732 | 0.732 | 0.732 | 0.549 | 0.549 |
| Test Hypothesis | | Baseline (similar | Lower FAW | Variable FAW across | Decrease gap further | Open nip gap |
| | | material but uniform | than upper | width, add release paper | and slow speed- | slightly to |
| | | thickness*) normal | jacket so | to apply uniform pressure | allow additional | decrease |
| | | pre-pregging | decrease | across the width | time at temperature | distortion - |
| | | conditions | gap** | | for infusion | fine tuning |
| Results | | | | | | |
| Appearance/Distortion Level | | 1 | 1 | 2 | 3 | 4 |
| High (588 g/m²) | Tg Onset (° C.) | | | | 90.8 | 113.3 |
| FAW | Peak Storage Modulus (Mpa) | | | | 10630.0 | 38397.2 |
| (center sample) | Tg Peak TanDelta (° C.) | | | | 162.1 | 142.6 |
| | Fiber Content (wt %) | | | | 70.5 | 61.1 |
| | Density (g/cm³) | | | | 1.6 | 1.5 |
| | Void Content (vol %) | | | | 0.7 | 1.4 |
| Low (520 g/m²) | Tg Onset (° C.) | | | | 126.5 | 128.8 |
| FAW | Peak Storage Modulus (Mpa) | | | | 6653.0 | 37813.0 |
| (drive side | Tg Peak TanDelta (° C.) | | | | 166.4 | 163.2 |
| sample) | Fiber Content (wt %) | | | | 66.2 | 59.7 |
| | Density (g/cm³) | | | | 1.5 | 1.5 |
| | Void Content (vol %) | | | | 0.6 | 1.0 |

Notes for Table II:
*“uniform thickness” refers to a prepreg that did not have a variable fiber areal weight.
**“lower FAW that upper jacket so decrease gap” - this variable FAW material has a lower overall FAW than the baseline so the nip gap was decreased.

A rating scale was developed to indicate the “Appearance/Distortion Level” of a sample to determine if a sample passes the necessary criteria to subject the sample to further testing. The rating scale includes a numerical rating level of “1” to “4” with “1” being the least acceptable and “4” being the most acceptable. A more detail description of the rating levels 1-4 are described in Table IV. A sample having an appearance/distortion rating level of 3 is required for further testing of the sample.

TABLE IV
Appearance/Distortion Rating Scale

| Rating | Brief Description of | |
|---|---|---|
| Level | Appearance/Distortion | Comment |
| 1 | Poor, dry fibers, resin layer on top. | Unacceptable |
| 2 | Heavy fiber distortion. | Unacceptable |
| 3 | Appearance is acceptable; distortion | Acceptable |
| | is still noticed in some areas. | |
| 4 | Appearance is acceptable; very little | Acceptable |
| | distortion is noticed. | |

What is claimed is:

1. A process for producing a prepreg product comprising the steps of:
(a) providing a fast curing resin composition;
(b) forming a film of the resin from step (a) on the surface of one side of a sheet of release substrate;
(c) providing a sheet of a fiber fabric substrate having a cross-sectional thickness of a varying fiber areal weight;
(d) contacting the surface of at least one side of the sheet of fiber fabric substrate of step (c) with the resin side of the sheet of resin film of step (b) such that the resin contacts the fiber fabric substrate;
(e) applying pressure on the surface of the other side of the sheet of release substrate opposite the resin film to impregnate the fiber fabric substrate with the fast curing resin composition and to obtain a uniform impregnation of resin across the width of the variable fiber areal weight fiber fabric substrate; and
(f) allowing the fiber fabric substrate impregnated with the fast curing resin composition of step (e) to at least partially cure the resin to form a prepreg product.

2. The process of claim 1, wherein the fast curing resin composition is an epoxy resin polymer.

3. The process of claim 1, wherein the fiber fabric substrate is a carbon fiber fabric substrate.

4. The process of claim 1, wherein the fiber fabric substrate impregnated with the fast curing resin composition of step (f) is heated at a temperature sufficient to at least partially cure the resin to form a prepreg product.

5. The process of claim 4, wherein the temperature is from 100° C. to 130° C.

6. The process of claim 1, wherein the fiber fabric substrate is a fiber areal weight hybrid carbon fiber broadgood.

7. A resin impregnated fabric prepreg made by the process of claim 1.

8. A process for producing a fiber reinforced composite article comprising:
(A) providing a resin impregnated fabric prepreg made by the process of claim 1; and
(B) curing the impregnated fabric prepreg of step (A) to form a fiber reinforced composite article.

9. A fiber reinforced composite article made by the process of claim 8.

10. A molded fiber reinforced composite article made by the process of claim 8.

11. A process for making a carbon fiber reinforced composite comprising:
(a) providing a fast curing resin composition;
(b) forming a film of the resin from step (a) on the surface of one side of a sheet of release substrate;
(c) providing a sheet of a fiber fabric substrate having a cross-sectional thickness of a varying fiber areal weight;
(d) contacting the surface of at least one side of the sheet of fiber fabric substrate of step (c) with the resin of the sheet of resin film of step (b);
(e) applying pressure on the surface of the other side of the sheet of release substrate opposite the resin film to impregnate the fiber fabric substrate with the fast curing resin composition to obtain a uniform impregnation of resin across the width of the variable fiber areal weight fiber fabric substrate;
(f) allowing the fiber fabric substrate impregnated with the fast curing epoxy resin composition of step (e) to partially cure to form a prepreg product; and
(g) curing the prepreg product of step (f) to form a cured carbon fiber reinforced composite.

12. The process of claim 11, wherein the temperature of the curing step (g) is from 140° C. to 155° C.

13. The process of claim 11, wherein the curing time of the curing step (g) is from 3 minutes to 5 minutes.

14. A nip roll assembly apparatus for receiving a plurality of sheet members including at least one sheet of a fiber fabric substrate having a cross-sectional thickness of a varying fiber areal weight and at least one sheet of release paper containing a film of a facing curing resin composition releasably attached thereto; said nip roll assembly apparatus used for producing a resin-impregnated prepreg product; said nip roll assembly apparatus comprising: an S-wrap compaction roll assembly including a combination of at least a first, a second and a third nip roller in rotational contact with each other; wherein the second nip roller is disposed in a sandwiched position between the first and third nip rollers; wherein the second roller includes a diameter modified to provide a uniform pressure across the surface of one side of the sheet of release paper opposite the side of the resin film to impregnate the fiber fabric substrate with the fast curing resin composition and to obtain a uniform impregnation of the resin across the width of the variable fiber areal weight fiber fabric substrate.
